(19) United States
(12) Patent Application Publication
(10) Pub. No.: US 2022/0129862 A1
(43) Pub. Date: Apr. 28, 2022

(54) DISPLAY CONTROL DEVICE, DISPLAY CONTROL METHOD, AND RECORDING MEDIUM

(71) Applicant: NEC Corporation, Minato-ku, Tokyo (JP)

(72) Inventors: Jun UCHIMURA, Tokyo (JP); Sayaka TAKAHASHI, Tokyo (JP); Yuji TAHARA, Tokyo (JP)

(73) Assignee: NEC Corporation, Minato-ku, Tokyo (JP)

(21) Appl. No.: 17/423,057

(22) PCT Filed: Mar. 9, 2020
(86) PCT No.: PCT/JP2020/009934

§ 371 Date: Jul. 14, 2021

(30) Foreign Application Priority Data
Mar. 20, 2019 (JP) 2019-053723

(51) Int. Cl. G06Q 10/00; G06F 3/14

(52) U.S. Cl. CPC G06Q 10/20; G06F 3/14

(57) ABSTRACT

A display control device according to the present invention includes: a memory; and at least one processor coupled to the memory. The processor performs operations. The operations include: determining a start of handling of a target facility; and changing display on an advertisement display device from an advertisement to a handling description of the target facility when determining the start of the handling.

### TECHNICAL FIELD

The present disclosure relates to display of information regarding handling of a facility or the like.

### BACKGROUND ART

In a retail industry such as a convenience store, a facility or a device for providing a product is complicated in order to achieve a high added value of the product. Therefore, complicated work occurs in maintenance of the facility or the like.

With the complication of the maintenance work, it is difficult for a worker such as a salesclerk to understand a maintenance manual only by a description using characters. Therefore, an electronic manual is displayed on a liquid crystal display or the like and used.

As a technique related to manual display, for example, there are patent literatures (PTLs) 1 to 3. A vending machine disclosed in PTL 1 displays, in a maintenance mode, information for the maintenance mode on a display unit for settlement. A vending machine disclosed in PTL 2 switches a display mode of a display unit from a product sales mode to a maintenance mode when a cabinet is opened. A vending machine disclosed in PTL 3 uses a keyboard to switch information to be displayed on a panel display device between general information such as advertisement information and traffic guidance, and management information such as the number of sales and a failure status.

PTL 4 discloses a technique related to a maintenance work time. A control device of a vending machine disclosed in PTL 4 turns on a sold-out lamp of the vending machine at a set maintenance start time in order to prevent the vending machine from being used by a user at the time of maintenance.

### CITATION LIST

### Patent Literature

### [PTL 1] JP 2017-142612 A

### [PTL 2] JP 2008-097211 A

### [PTL 3] JP 1997 (H09)-270061 A

### [PTL 4] JP 1997 (H09)-265563 A

### SUMMARY OF INVENTION

### Technical Problem

A vending machine includes a large housing, and thus can include a display having such a size that the display can display information regarding maintenance. However, some facilities in a retail store cannot display a maintenance manual although the facilities require maintenance.

An object of the present disclosure is to provide a display control device or the like that displays, to a worker or the like, a manual or the like of a facility that cannot display the manual or the like in a store.

### Solution to Problem

A display control device in one aspect of the present disclosure includes:

a start determination means for determining a start of handling of a target facility; and

a display change means for changing display on an advertisement display device from an advertisement to a handling description of the target facility when the start determination means determines the start of the handling.

In a display control method in one aspect of the present disclosure,

a display control device

determines a start of handling of a target facility, and

changes display on an advertisement display device from an advertisement to a handling description of the target facility when the start of the handling is determined.

A recording medium in one aspect of the present disclosure records, in a computer-readable manner, a program that causes a computer to execute:

a process of determining a start of handling of a target facility; and

a process of changing display on an advertisement display device from an advertisement to a handling description of the target facility when the start of the handling is determined.

### Advantageous Effects of Invention

An effect of the present disclosure is that it is possible to display a manual or the like of a facility that cannot display the manual or the like to a worker or the like.

### BRIEF DESCRIPTION OF DRAWINGS

FIG. 1 is a block diagram illustrating a configuration of a display control device in a first example embodiment.

FIG. 2 is a block diagram illustrating a configuration of a display system including the display control device in the first example embodiment.

FIG. 3 is a flowchart illustrating an operation of changing an advertisement to a handling description in the first example embodiment.

FIG. 4 is a flowchart illustrating an operation of changing the handling description to the advertisement in the first example embodiment.

FIG. 5 is a flowchart illustrating an operation of displaying the acquired handling description in the first example embodiment.

FIG. 6 is a flowchart illustrating an operation of displaying a handling description associated to acquired facility information in the first example embodiment.

FIG. 7 is a block diagram illustrating a schematic configuration of the display control device in the first example embodiment.

FIG. 8 is a block diagram illustrating a configuration of a display control device in a second example embodiment.

FIG. 9 is a block diagram illustrating a configuration of a display system 11 including the display control device in the second example embodiment.

FIG. 10 is a flowchart illustrating an example of an operation associated to person information in the second example embodiment.

FIG. 11 is a diagram illustrating an example of a relationship between the person information and display contents.

FIG. 12 is a flowchart illustrating an example of an operation associated to history information in the second example embodiment.

FIG. 13 is a diagram illustrating an example of the history information used for the description.

FIG. 14 is a flowchart illustrating an example of an operation associated to person position information in the second example embodiment.

FIG. 15 is a block diagram illustrating a configuration of a display control device in a third example embodiment.

FIG. 16 is a block diagram illustrating a configuration of a display system including the display control device in the third example embodiment.

FIG. 17 is a diagram illustrating an example of displaying an item in the third example embodiment.

FIG. 18 is a flowchart illustrating an example of operations of displaying the item and acquiring a result in the third example embodiment.

FIG. 19 is a block diagram illustrating an example of a hardware configuration of a computer.

### EXAMPLE EMBODIMENT

Example embodiments will be described in detail with reference to the drawings. In the drawings and the example embodiments described in the specification, the same reference signs are given to similar components, and a description thereof will be omitted as appropriate.

A “target facility” is a facility for which a handling description to be described later is displayed in the example embodiments. For example, the target facility is a facility handled by a salesclerk or the like.

In the description of the example embodiments, “handling” is “handling” by a person who handles the target facility as a business. For example, an example of the “handling” in the example embodiments is a case where a store clerk handles a facility installed in a store. An owner of the target facility and the person that handles the target facility do not necessarily need an employment relationship. For example, the “handling” in the example embodiments includes a case where the store clerk handles the target facility rented by the store.

Contents of the “handling” are not limited. For example, the “handling” is cleaning, inspection (for example, confirmation of a state of consumables and parts), maintenance, supply of consumables, and adjustment and replacement of parts of the target facility, movement and installation of the facility, and start and stop of the facility.

The target facility may be an independent facility or a part of a facility.

The “handling description” is information regarding the handling of the target facility (for example, a drawing or a description of a method for handling the facility). The handling description is displayed on an advertisement display device to be described later. Therefore, the handling description in the example embodiments is data in a form in which the data can be displayed on the advertisement display device (for example, an electronic file).

Note that the handling description of the target facility may be one piece of data (for example, one file) or a collection of a plurality of pieces of data (for example, a collection of files for each chapter). For example, in a case where the target facility includes a plurality of parts, the handling description may be a set of files associated to corresponding parts.

In addition, a data format of the handling description is not limited to a data format displayed from the head, and may be a data format in which the contents can be displayed even from the middle. For example, in the case where the target facility includes a plurality of parts, the handling description may be in a data format in which contents associated to the parts can be displayed first. For example, the handling description may be data in a format in which information corresponding to an index or a table of contents is included and display contents can be selected on the basis of the information.

In addition, the name and contents of the handling description are not limited as long as the name and contents relate to the handling of the facility or the like. For example, the handling description may be a manual, a standard operating procedure, (work) instruction manual, a (work) procedure manual, a handbook, a guidebook, a teaching material, or the like.

The “advertisement display device” is a display device installed in a building (for example, a store, a room, a hall, or a corridor) in which the target facility is installed, and normally displays an advertisement. Contents of the advertisement to be displayed are not limited. For example, in a case of the advertisement display device in the store, the advertisement display device may display, as the advertisement, an advertisement related to a product in the store, may display an advertisement related to a company that manages the store, or may display an advertisement of a product of another corporation or another company.

Furthermore, the advertisement display device of the example embodiments is controlled by a display control device in the present disclosure, and displays the handling description in addition to the advertisement.

A “store server” is a server that executes management of a store or the like. A function of the store server is not limited. However, in the example embodiments, the store server stores at least a part of the handling description in a storage device or the like, and transmits the handling description to the display control device when receiving a request.

### First Example Embodiment

A first example embodiment will be described.

First, a configuration of a display system 10 including a display control device 100 will be described as a reference for understanding the display control device 100 in the first example embodiment.

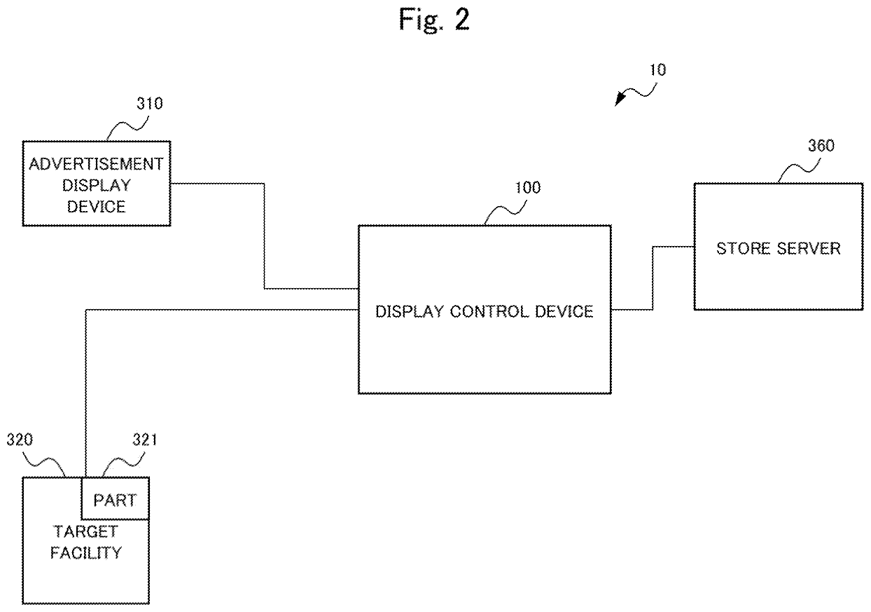

FIG. 2 is a block diagram illustrating the configuration of the display system 10 including the display control device 100 in the first example embodiment. Referring to FIG. 2, the display system 10 includes the display control device 100, an advertisement display device 310, a target facility 320, and a store server 360.

The advertisement display device 310 displays the advertisement and the handling description. More specifically, the advertisement display device 310 is controlled by the display control device 100 to change contents to be displayed to the advertisement and the handling description.

The target facility 320 is a facility as a target of the handling description to be displayed on the advertisement display device 310. That is, the advertisement display device 310 displays the handling description related to the target facility 320.

Note that the target facility 320 may include one or more parts 321. In this case, the target of the handling description may include at least a part of the parts 321.

The store server 360 sends the handling description to the display control device 100.

The display control device 100 changes the display on the advertisement display device 310 from the advertisement to the handling description. For example, in a case where a predetermined person (for example, a salesclerk) handles the target facility 320, the display control device 100 changes the display on the advertisement display device 310 from the advertisement to the handling description.

Next, a configuration of the display control device 100 will be described.

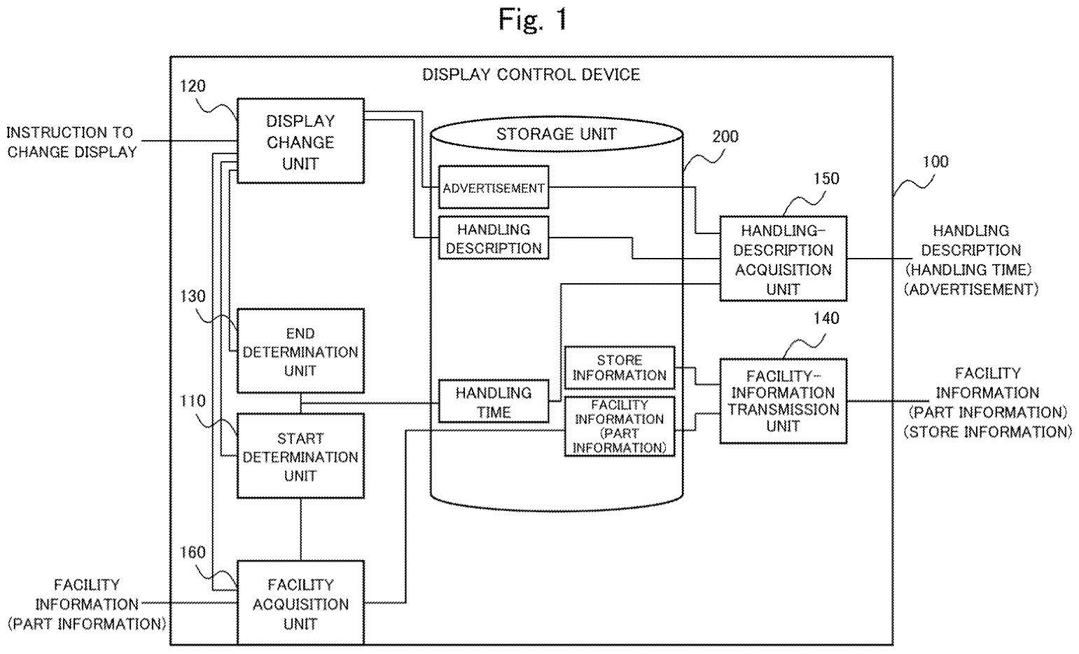

FIG. 1 is a block diagram illustrating the configuration of the display control device 100 in the first example embodiment. Referring to FIG. 1, the display control device 100 includes a start determination unit 110, a display change unit 120, and a storage unit 200. The display control device 100 further includes an end determination unit 130, a facility-information transmission unit 140, a handling-description acquisition unit 150, and a facility acquisition unit 160.

The start determination unit 110 determines a start of handling of the target facility 320. More specifically, the start determination unit 110 determines the start of the handling by using a predetermined condition (hereinafter referred to as a “start condition”).

For example, in a case where the target facility 320 is maintained in a predetermined time zone every day, the start determination unit 110 may detect a start time of the handling by using a clocking function of a clock (not illustrated) or the like and determine the start of the handling. The start time is an example of the start condition.

Alternatively, in a case where the target facility 320 is maintained every predetermined number of times of use, the start determination unit 110 may measure the number of times of use of the target facility 320 and determine the start of the handling on the basis of the measured number of times of use. The number of times of use is an example of the start condition.

The start determination unit 110 may use another condition. For example, it is desirable to maintain the target facility 320 when there is no customer. Therefore, for example, the start determination unit 110 may determine the start of the handling when the customer is absent after the start time, by using a human sensor that detects the customer.

Alternatively, the salesclerk may go out of a store for work or the like. In such a case, the advertisement display device 310 does not need to display the handling description. Therefore, the start determination unit 110 may determine the start of the handling when the salesclerk is in the store after the start time. In this case, the start determination unit 110 can acquire position information of the salesclerk by using a beacon installed in the store, and determine whether the salesclerk is in the store on the basis of the acquired position information.

When determining the start of the handling, the start determination unit 110 notifies the display change unit 120 of the start.

The start determination unit 110 may use another facility or device. For example, the start determination unit 110 may cooperate with a point-of-sale (POS) terminal of the store. For example, when the start determination unit 110 receives, from the POS terminal, a notification that a product related to the target facility 320 has been purchased in a predetermined time zone before the start time, the start determination unit 110 does not have to determine the start of the handling even at the start time.

As an example, a case where the target facility 320 is a coffee machine will be described. When a coffee provided by the coffee machine has been purchased, the coffee machine performs an operation for providing the purchased coffee to the customer. For example, when a notification that the coffee provided by the coffee machine has been purchased is received from the POS terminal, the start determination unit 110 does not have to determine the start of handling of the coffee machine for a predetermined period of time from the purchase. As a result, the display control device 100 executes control not to display a handling description of the coffee machine when the coffee related to the coffee machine has been purchased.

The end determination unit 130 determines an end of the handling of the target facility 320. More specifically, the end determination unit 130 determines the end of the handling by using a predetermined condition (hereinafter referred to as an “end condition”).

For example, in a case where the target facility 320 is maintained in a predetermined time zone every day, the end determination unit 130 may detect an end time of the maintenance by using the clocking function of the clock (not illustrated) or the like and determine the end of the handling. Alternatively, the end determination unit 130 may determine the end of the handling after a predetermined required time (for example, a standard maintenance work time) has elapsed since the determination of the start by the start determination unit 110. The end time and the required time are examples of the end condition.

Furthermore, the end determination unit 130 may use another condition. For example, when there is the customer in the store, it is desirable that the advertisement display device 310 displays the advertisement rather than the handling description. Therefore, for example, the end determination unit 130 may determine the end of the handling when the presence of the customer is detected, by using the human sensor provided in the store.

The end determination unit 130 may use another facility or device. For example, the end determination unit 130 may cooperate with the POS terminal of the store. For example, the end determination unit 130 may determine the end of the handling when a notification that the product related to the target facility 320 has been purchased is received from the POS terminal.

As an example, a case where the target facility 320 is the coffee machine will be described. For example, when a notification that a coffee of the coffee machine has been purchased is received from the POS terminal, the end determination unit 130 may determine the end of the handling. As a result, the display control device 100 executes control not to display the handling description of the coffee machine when the coffee related to the coffee machine has been purchased.

When determining the end of the handling, the end determination unit 130 notifies the display change unit 120 of the end.

As described above, the start determination unit 110 and the end determination unit 130 may use the start time and the end time of the handling. Alternatively, the start determination unit 110 and the end determination unit 130 may use the start time and the required time of the handling. FIG. 1 collectively illustrates the start time and the end time, the start time and the required time, and the like as a handling time.

When the start determination unit 110 determines the start of the handling, the display change unit 120 changes the display on the advertisement display device 310 from the advertisement to the handling description. For example, the display change unit 120 may transmit an instruction to change the display and the handling description stored in the storage unit 200 to the advertisement display device 310 to change the display. Note that, in a case where the advertisement display device 310 stores the handling description, the display change unit 120 does not have to transmit the handling description. As an example of this case, a case is assumed where the advertisement display device 310 includes a storage device (not illustrated) and stores the advertisement and the handling description.

Note that the display change unit 120 may change a part of the display of the advertisement on the advertisement display device 310 to the display of the handling description. In other words, the display change unit 120 may display both the advertisement and the handling description on the advertisement display device 310.

Furthermore, when the end determination unit 130 determines the end of the handling, the display change unit 120 changes the display on the advertisement display device 310 from the handling description to the advertisement. In this case, the display change unit 120 may transmit the advertisement to the advertisement display device 310 as necessary.

Note that the start determination unit 110 may determine a plurality of types of starts of the handling as the start of the handling. In this case, the start determination unit 110 may notify the display change unit 120 of the type of start of the handling. The display change unit 120 may change display contents of the handling description on the basis of the received type of start of the handling.

For example, it is assumed that a plurality of target facilities 320 is provided in the store. Furthermore, it is assumed that the target facilities 320 each have a different maintenance time zone. In this case, the start determination unit 110 determines the start of the handling according to a maintenance start time of each of the target facilities 320. The start determination unit 110 then notifies the display change unit 120 of information regarding a target facility 320 whose handling is determined to have been started. Note that the start determination unit 110 may use, as the information regarding the target facility 320, facility information to be described later in relation to the facility acquisition unit 160.

The display change unit 120 changes the display on the advertisement display device 310 from the advertisement to a handling description associated to the target facility 320 for which the handling start notification has been received.

Note that the display change unit 120 may change the display on the advertisement display device 310 so as to display a plurality of handling descriptions.

The end determination unit 130 may also determine a plurality of types of ends of the handling. In this case, the display change unit 120 may change the display according to the determined type of end of the handling. For example, in a case where the advertisement display device 310 displays the plurality of handling descriptions, the display change unit 120 may end display of a handling description related to a target facility 320 for which the handling end notification has been received.

The facility acquisition unit 160 acquires information regarding the target facility 320 (hereinafter referred to as “facility information”). For example, the facility acquisition unit 160 may acquire, as the facility information, information indicating the facility (for example, a product name, a model number, or a code of the facility) from the target facility 320.

Note that a method by which the facility acquisition unit 160 acquires the facility information is not limited.

For example, the target facility 320 may transmit the facility information to the facility acquisition unit 160 in response to a press of a maintenance mode button of the target facility 320 in a case where the salesclerk starts the maintenance of the target facility 320. In this case, the start determination unit 110 may determine, as the start of the handling, the acquisition of the facility information by the facility acquisition unit 160.

Alternatively, when determining the start of the handling, the start determination unit 110 may request the facility acquisition unit 160 to acquire the facility information. In this case, the facility acquisition unit 160 is only required to acquire the facility information from the target facility 320 on the basis of the request.

Note that, in a case where the target of the handling description is the part 321 of the target facility 320, the facility acquisition unit 160 may acquire the facility information including information regarding the part 321 as the target of the handling description (hereinafter, referred to as “part information”).

In this case, the display change unit 120 may change the display on the advertisement display device 310 to display of a handling description related to the part information acquired by the facility acquisition unit 160. In this case, the display change unit 120 may transmit the handling description related to the part information to the advertisement display device 310.

The facility-information transmission unit 140 transmits the facility information to the store server 360 in order to acquire the handling description from the store server 360. Note that the facility-information transmission unit 140 may transmit the part information.

Note that the store server 360 may manage a plurality of stores. The advertisement display device 310 may be different for each store. In such a case, the display control device 100 requires a handling description associated to a store as the handling description acquired from the store server 360. Therefore, the facility-information transmission unit 140 may transmit, in addition to the facility information, information regarding the store (hereinafter, referred to as “store information”) to the store server 360. Note that a method by which the storage unit 200 stores the store information is not limited. For example, a manager or the like of the display control device 100 may store the store information in the storage unit 200 in advance.

The handling-description acquisition unit 150 acquires the handling description from the store server 360. Furthermore, the handling-description acquisition unit 150 may acquire at least a part of the start condition and the end condition (for example, the handling time) in addition to the handling description. In addition, the handling-description acquisition unit 150 may acquire the advertisement displayed by the advertisement display device 310 from the store server 360.

The storage unit 200 stores information necessary for the operation of each component. Specifically, the storage unit 200 stores at least one of the handling description, the advertisement, the start condition, the end condition, the handling time, the facility information, the part information, and the store information.

Note that the storage unit 200 is not limited to the source of the above information. For example, the storage unit 200 may receive each piece of information from the store server 360 and store the information. Alternatively, the manager of the display control device 100 may store necessary information in the storage unit 200.

For example, in a case where the target facility 320 is fixed, the manager of the display control device 100 may store the facility information in the storage unit 200 in advance. In this case, the display control device 100 does not have to include the facility acquisition unit 160.

Note that each piece of information may be provided from a plurality of sources. For example, the advertisement may include an advertisement stored in advance by the manager of the display control device 100 and an advertisement acquired from the store server 360.

Next, an operation of the display control device 100 according to the first example embodiment will be described.

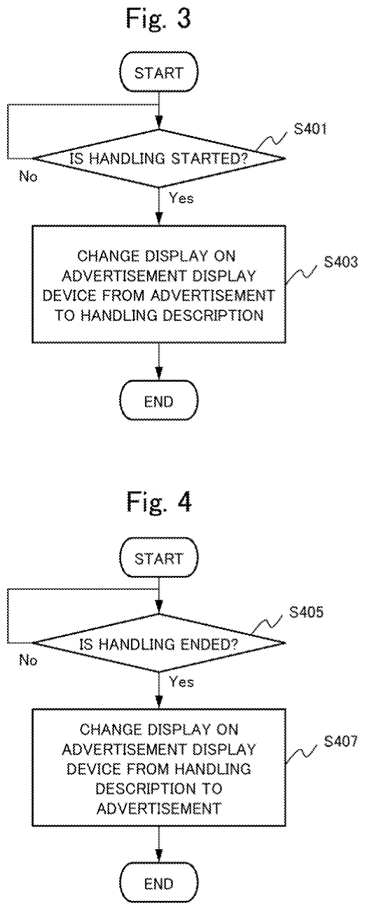

FIG. 3 is a flowchart illustrating an operation of changing the advertisement to the handling description in the first example embodiment.

The start determination unit 110 determines whether the handling is started by using a predetermined start condition (for example, the start time) (step S401). For example, the start determination unit 110 determines, as the start of the handling, the detection of the preset start time.

If the handling is not started (No in step S401), the start determination unit 110 repeats the above operation until the start of the handling is determined.

If the start of the handling is determined (Yes in step S401), the start determination unit 110 notifies the display change unit 120 of the start of the handling. For example, when detecting the preset start time, the start determination unit 110 notifies the display change unit 120 of the start of handling.

The display change unit 120 changes the display on the advertisement display device 310 from the advertisement to the handling description on the basis of the notification of the start of the handling from the start determination unit 110 (step S403).

FIG. 4 is a flowchart illustrating an operation of changing the handling description to the advertisement in the first example embodiment.

The end determination unit 130 determines whether the handling is ended by using a predetermined end condition (for example, the end time) (step S405). For example, when detecting the preset end time, the end determination unit 130 determines the end of the handling.

If the handling is not ended (No in step S405), the end determination unit 130 repeats the above operation until the end of the handling is determined.

If the end of the handling is determined (Yes in step S405), the end determination unit 130 notifies the display change unit 120 of the end of the handling.

The display change unit 120 changes the display on the advertisement display device 310 from the handling description to the advertisement on the basis of the notification of the end of the handling from the end determination unit 130 (step S407).

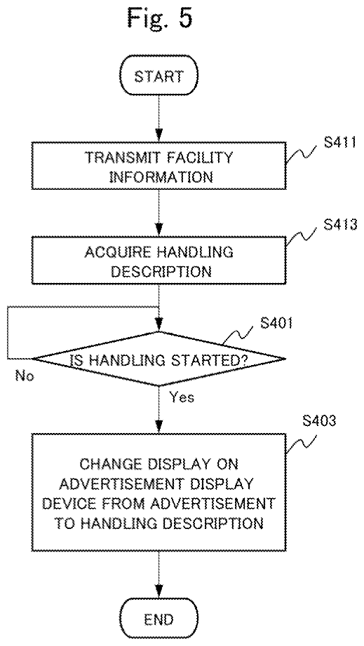

FIG. 5 is a flowchart illustrating an operation of displaying the acquired handling description in the first example embodiment.

The facility-information transmission unit 140 transmits the facility information to the store server 360 (step S411).

The handling-description acquisition unit 150 acquires the handling description from the store server 360 (step S413).

Operations after step S413 are similar to the operations described with reference to FIG. 3.

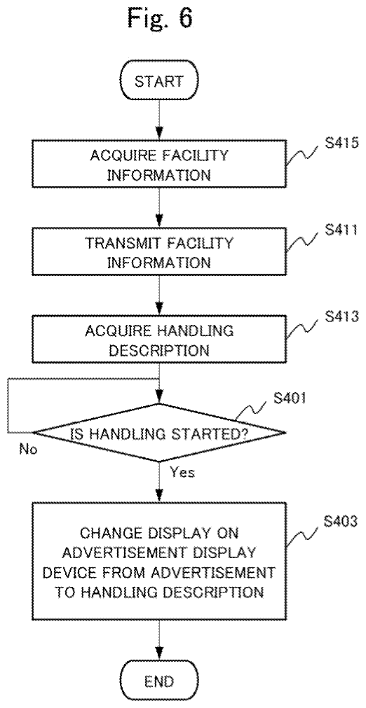

FIG. 6 is a flowchart illustrating an operation of displaying a handling description associated to the acquired facility information in the first example embodiment.

The facility acquisition unit 160 acquires the facility information (step S415).

Operations after step S415 are similar to the operations described with reference to FIG. 5.

Note that the display control device 100 may be included in the store server 360.

Alternatively, the display control device 100 may include the advertisement display device 310.

Next, effects of the first example embodiment will be described.

According to the first example embodiment, it is possible to display a manual or the like of a facility that cannot display the manual or the like to a worker or the like.

The reason is as follows.

The display control device 100 includes the start determination unit 110 and the display change unit 120. The start determination unit 110 determines the start of the handling of the target facility 320. When the start determination unit 110 determines the start of the handling, the display change unit 120 changes the display on the advertisement display device 310 from the advertisement to the handling description of the target facility 320.

Even in the case where the target facility 320 cannot display the handling description such as a manual, the display control device 100 can display, on the basis of the above configuration, the handling description such as the manual of the target facility 320 by using the advertisement display device 310.

Furthermore, for example, the start determination unit 110 may determine, as the start of the handling, the detection of the preset start time. In this case, for example, the display control device 100 can display the handling description to the worker or the like at a predetermined work start time (for example, a closing time) by using the advertisement display device 310.

Furthermore, the display control device 100 includes the end determination unit 130. The end determination unit 130 determines the end of the handling. When the end determination unit 130 determines the end of the handling, the display change unit 120 changes the display on the advertisement display device 310 from the handling description to the advertisement.

For example, the end determination unit 130 may determine, as the end of the handling, the detection of the preset end time. In this case, for example, the display control device 100 can return the display on the advertisement display device 310 to the display of the advertisement at a predetermined work end time (for example, an opening time).

The display control device 100 further includes the facility-information transmission unit 140 and the handling-description acquisition unit 150. The facility-information transmission unit 140 transmits the facility information of the target facility 320 to the store server 360 that stores the handling description of the target facility 320. The handling-description acquisition unit 150 acquires the handling description of the target facility 320 from the store server 360. The display change unit 120 then changes the display on the advertisement display device 310 to the display of the acquired handling description.

The store server 360 can acquire a latest handling description from a management department or the like via a network or the like. Therefore, the display control device 100 can display an appropriate handling description for the target facility 320 on the basis of the above configuration.

The display control device 100 further includes the facility acquisition unit 160.

The facility acquisition unit 160 acquires the facility information of the target facility 320. The facility-information transmission unit 140 transmits the facility information of the target facility 320 to the store server 360 that stores the handling description of the target facility 320. The handling-description acquisition unit 150 acquires the handling description of the target facility 320 from the store server 360. The display change unit 120 then changes the display on the advertisement display device 310 to the display of the acquired handling description.

For example, the facility in the store may be updated. Even in such a case, the display control device 100 can appropriately display the handling description associated to the facility in the store on the basis of the above configuration.

The facility acquisition unit 160 may acquire the information regarding the part 321 (the part information) of the target facility 320. In this case, the display control device 100 can display the handling description associated to the part 321.

Next, an outline of the display control device 100 in the first example embodiment will be described.

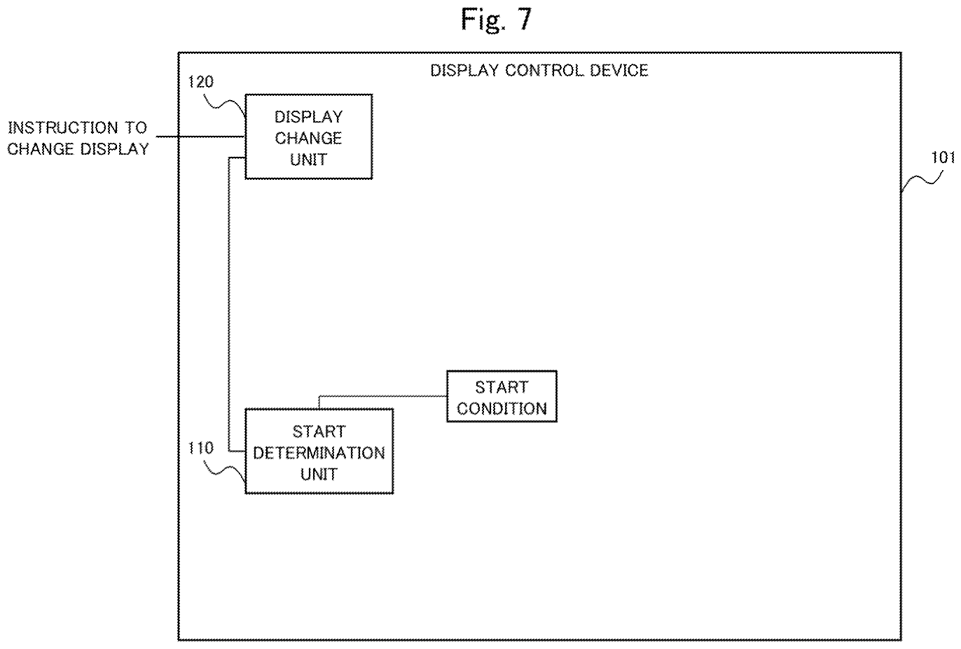

FIG. 7 is a block diagram illustrating a configuration of a display control device 101, which is the outline of the display control device 100 in the first example embodiment.

The display control device 101 includes the start determination unit 110 and the display change unit 120. The start determination unit 110 determines the start of the handling of the target facility 320. When the start determination unit 110 determines the start of the handling, the display change unit 120 changes the display on the advertisement display device 310 from the advertisement to the handling description of the target facility 320.

In the display control device 101 based on the above configuration, when the start determination unit 110 determines that a predetermined start condition is satisfied, the display change unit 120 changes the display on the advertisement display device 310 from the advertisement to the handling description.

Similarly to the display control device 100, the display control device 101 configured as described above can obtain an effect of displaying a manual or the like of a facility that cannot display the manual or the like to a worker or the like.

This is because each component in the display control device 101 operates similarly to a corresponding component in the display control device 100.

The display control device 101 has the minimum configuration in the first example embodiment.

### Second Example Embodiment

A second example embodiment will be described.

First, a configuration of a display system 11 including a display control device 102 will be described as a reference for understanding the display control device 102 in the second example embodiment.

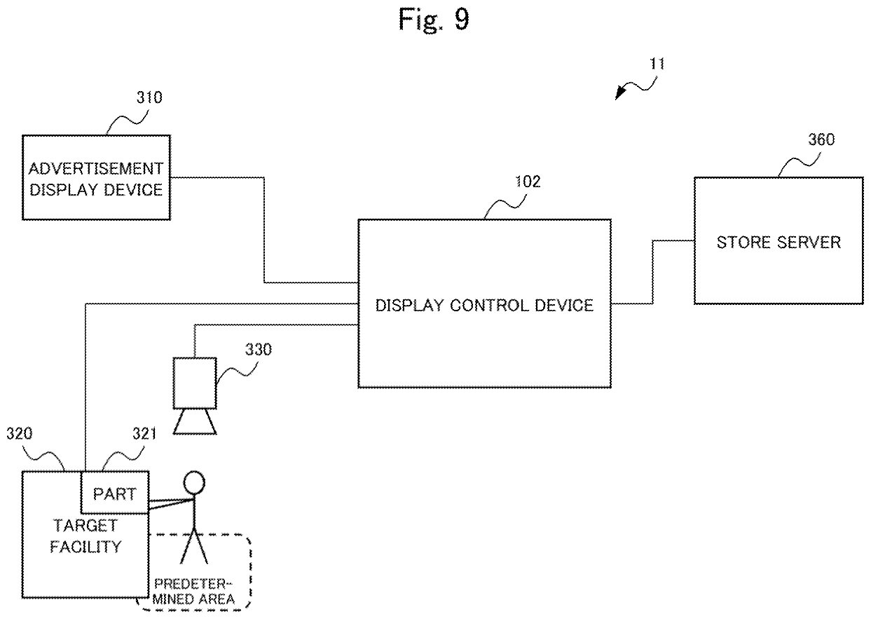

FIG. 9 is a block diagram illustrating the configuration of the display system 11 including the display control device 102 in the second example embodiment. Referring to FIG. 9, the display system 11 includes the display control device 102, an advertisement display device 310, a target facility 320, a store server 360, and a person identification device 330.

Since the advertisement display device 310, the target facility 320, and the store server 360 are similar to those of the first example embodiment, a detailed description thereof will be omitted.

The person identification device 330 identifies a person who handles the target facility 320. A method by which the person identification device 330 identifies the person is not limited. For example, the person identification device 330 may identify the person by applying a predetermined image recognition method to an image captured by a camera, or may read information of a portable article carried by the person. The portable article is, for example, a device including an RF tag, an integrated circuit (IC) card, or the like.

The person identification device 330 then outputs information regarding the identified person (hereinafter, referred to as “person information”) to the display control device 102. The person information is not limited. For example, the person information may be information for identifying a salesclerk (for example, an employee number or a name).

For example, it is assumed that a card of the salesclerk is a magnetic card. In this case, the person identification device 330 is a magnetic card reader that reads information of the magnetic card. For example, when starting to handle the target facility 320, the salesclerk causes the magnetic card reader to read the information of the magnetic card. The magnetic card reader (the person identification device 330) then transmits the read information to the display control device 102.

Note that the display control device 102 may include the person identification device 330. Alternatively, the target facility 320 may include the person identification device 330.

In addition to the function of the display control device 100, the display control device 102 changes display of a handling description to be displayed on the advertisement display device 310 on the basis of the person information acquired from the person identification device 330.

Furthermore, the person identification device 330 may output information regarding a position of the person (hereinafter, referred to as “person position information”) in addition to the person information. For example, in the case of handling the target facility 320, a person in charge of handling is located in a predetermined area for the target facility 320. That is, the position of the person relates to the handling of the target facility 320. Therefore, the person identification device 330 may output, as the person position information, information indicating whether the identified person is located in the predetermined area for the target facility 320.

A method by which the person identification device 330 identifies the position of the person is not limited. For example, the person identification device 330 may identify the position of the person by applying a predetermined image recognition method to an image captured by the camera, or may read position information of the portable article carried by the person.

The display control device 102 may change the display on the advertisement display device 310 on the basis of the person position information.

Next, a configuration of the display control device 102 will be described.

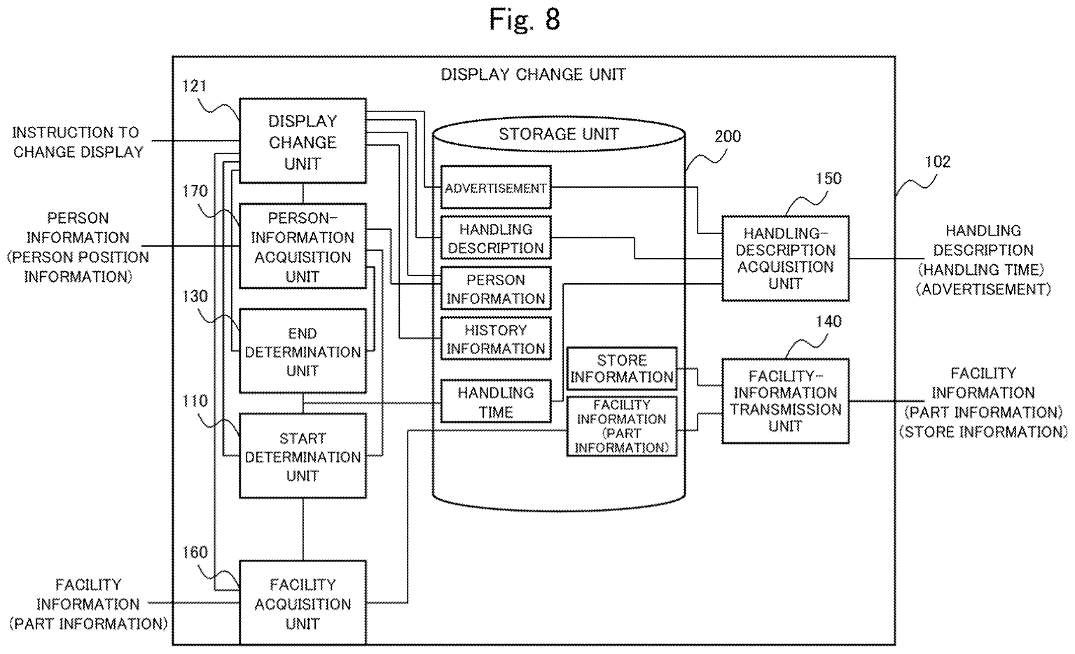

FIG. 8 is a block diagram illustrating the configuration of the display control device 102 in the second example embodiment.

Referring to FIG. 8, the display control device 102 includes a display change unit 121 instead of the display change unit 120 as compared with the display control device 100. The display control device 102 further includes a person-information acquisition unit 170. Furthermore, a storage unit 200 stores the person information and history information in addition to the information in FIG. 1. Other components are similar to those of the first example embodiment. Therefore, a component specific to the second example embodiment will be described in detail, and a description of a component similar to that of the first example embodiment will be omitted.

The person-information acquisition unit 170 acquires the person information from the person identification device 330. The person-information acquisition unit 170 then transmits the person information to the display change unit 121.

Note that the person-information acquisition unit 170 may store the person information in the storage unit 200. In this case, the display change unit 121 may use the person information stored in the storage unit 200.

In addition to the function of the display change unit 120, the display change unit 121 changes display contents of the handling description to be displayed on the advertisement display device 310 on the basis of the person information.

In the second example embodiment, the person is not limited. For example, the person may be a salesclerk, a maintenance staff dispatched to a store, or a customer.

As an example, a case where the person is a salesclerk will be described. In a case where there is a plurality of salesclerks in the store, skills of the salesclerks may be different. Here, it is assumed that there are a salesclerk who is accustomed to handling the target facility 320 (hereinafter referred to as an “expert”) and a salesclerk who is unaccustomed to the handling (hereinafter referred to as a “newcomer”). For example, in the case of maintaining the target facility 320, the expert can proceed with work on the basis of a maintenance outline. On the other hand, the newcomer requires a detailed description.

Therefore, the display change unit 121 refers to the person information to change the contents of the handling description to be displayed on the advertisement display device 310. For example, in the case of the expert, the display change unit 121 changes the display to display of the outline included in the handling description. On the other hand, in the case of the newcomer, the display change unit 121 changes the display to the display of the detailed handling description.

Note that the storage unit 200 may further store the history information. The history information is a history of the handling of the target facility 320 by the person in the past. For example, a storekeeper of the store may store the history information of the salesclerks in the storage unit 200 of the display control device 102 on the basis of results of past work of the salesclerks.

In a case where the storage unit 200 stores the history information, the display change unit 121 may change the contents of the handling description to be displayed on the basis of the person information and the history information.

For example, the history information may include a person's past experience of handling the target facility 320 (for example, having a lot of use experience or no use experience). In this case, the display change unit 121 may change the display contents on the basis of the experience. For example, in a case where the history information indicates that the person has a lot of experience of using the target facility 320, the display change unit 121 may change the display on the advertisement display device 310 from the display of the advertisement to the display of the outline of the handling description. On the other hand, in a case where the history information indicates that the person has no experience of using the target facility 320, the display change unit 121 may change the display on the advertisement display device 310 from the display of the advertisement to the display of the detailed handling description.

Alternatively, the history information may include a person's past work status for the target facility 320 (for example, “careful work, rough work, or work omission” or “excellent, good, acceptable, or unacceptable”). In this case, the display change unit 121 may change the display contents on the basis of the work status. For example, in a case where the history information indicates that the person has made a work omission, the display change unit 121 may change display of a handling description related to the omitted work to display for calling attention (for example, display in a different color or a large display). Alternatively, the display change unit 121 may display display contents other than the handling description on the basis of the work status. For example, in a case where the history information indicates that the person has done rough work, the display change unit 121 may add display contents that recommend careful work to the display of the handling description.

Furthermore, the person-information acquisition unit 170 may acquire the person position information.

In this case, a start determination unit 110 and an end determination unit 130 may use the person position information. For example, the start determination unit 110 may determine a start of the handling when the person position information satisfies a predetermined condition. Alternatively, the end determination unit 130 may determine an end of the handling when the person position information satisfies a predetermined condition.

A specific example will be described. First, the predetermined area is an area that the person enters when the person handles the target facility 320. The person position information includes information indicating whether the person enters the predetermined area for the target facility 320. Note that the person position information may include information indicating that the person does not enter the predetermined area for the target facility 320.

For example, when the salesclerk handles the target facility 320, the salesclerk enters the predetermined area. Therefore, in a case where the person position information includes information indicating the entry of the person into the predetermined area, the start determination unit 110 may determine the start of the handling. That is, the start determination unit 110 may detect the entry of the person into the predetermined area, and determine the start of the handling when detecting the entry into the predetermined area. Specifically, the start determination unit 110 may detect the entry of the person into the predetermined area by using an image of a camera installed in the store, or may detect the entry of the person into the predetermined area by using a human sensor included in the target facility 320.

In a time zone when there are many customers, there is a possibility that the entry into the predetermined area may occur even when the target facility 320 is not handled. Therefore, the start determination unit 110 may determine, as the start of the handling, an entry after a start time of the handling, which is stored in the storage unit 200 or the like.

On the other hand, when the person finishes handling the target facility 320, the person exits the predetermined area.

Therefore, the end determination unit 130 may determine the end of the handling in a case where the person position information does not include the information indicating the entry into the predetermined area (or in a case where the person position information includes the information indicating that the person does not enter the predetermined area). That is, the end determination unit 130 may detect the exit of the person from the predetermined area, and determine the end of the handling when detecting the exit from the predetermined area. Specifically, the end determination unit 130 may detect the exit of the person from the predetermined area by using an image of the camera installed in the store, or may detect the exit of the person from the predetermined area by using the human sensor included in the target facility 320.

Note that, similarly to the start determination unit 110, the end determination unit 130 may determine, as the end of the handling, an exit after a predetermined time (for example, an end time).

Next, an operation of the second example embodiment will be described.

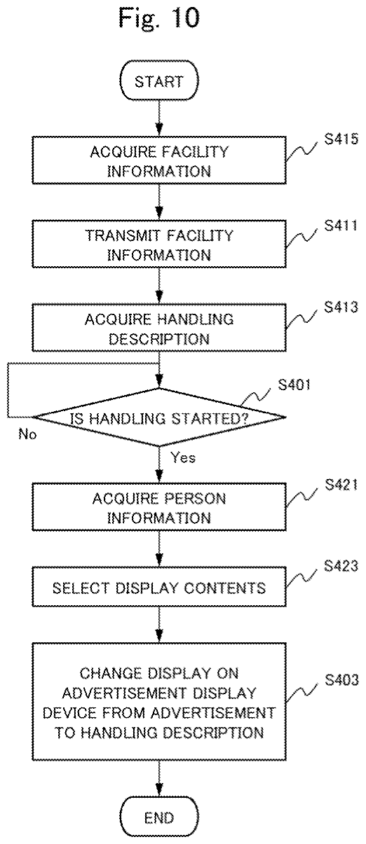

FIG. 10 is a flowchart illustrating an example of an operation associated to the person information in the second example embodiment.

Since operations up to step S401 are similar to those of the first example embodiment, a detailed description thereof will be omitted.

The person-information acquisition unit 170 acquires the person information (step S421).

Note that the order of the operations in steps S401 and S421 may be changed.

The display change unit 121 selects the display contents of the handling description to be displayed on the basis of the person information (step S423).

An example of the selection operation by the display change unit 121 will be described with reference to the drawings.

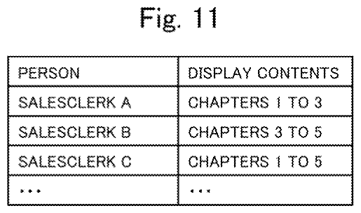

FIG. 11 is a diagram illustrating an example of a relationship between the person information and the display contents. A manager or the like of the display control device 102 stores information illustrated in FIG. 11 in the storage unit 200 in advance.

Here, for example, it is assumed that the person-information acquisition unit 170 acquires a salesclerk A as the person information. In this case, the display change unit 121 selects chapters 1 to 3 as the display contents.

The display change unit 121 then changes the display on the advertisement display device 310 from the advertisement to the handling description so as to display the selected display contents (step S403).

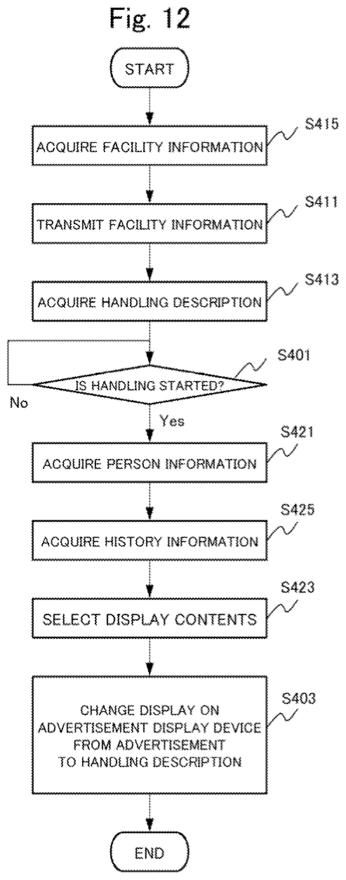

FIG. 12 is a flowchart illustrating an example of an operation associated to the history information in the second example embodiment.

Since operations up to step S421 are similar to those in FIG. 10, a detailed description thereof will be omitted.

The display change unit 121 acquires the history information of the person related to the person information (step S425).

Note that the order of the operations in steps S401, and, S421 and S425 may be changed.

The display change unit 121 selects the display contents of the handling description to be displayed on the basis of the person information and the history information (step S423).

An example of the selection operation by the display change unit 121 will be described with reference to the drawings.

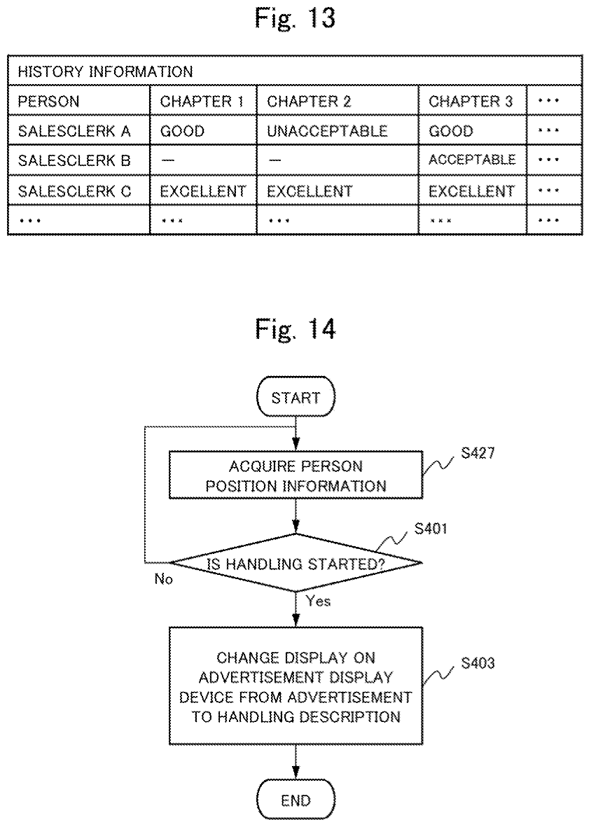

FIG. 13 is a diagram illustrating an example of the history information used for the description. The manager or the like of the display control device 102 stores history information illustrated in FIG. 13 in the storage unit 200 in advance.

The display change unit 121 uses the information in FIGS. 11 and 13.

Here, for example, it is assumed that the person-information acquisition unit 170 acquires the salesclerk A as the person information. In this case, the display change unit 121 selects the chapters 1 to 3 as the display contents by using the information in FIG. 11. Furthermore, the display change unit 121 displays display contents of the chapter 2, which indicates “unacceptable” in FIG. 13, by using a display format for calling attention (for example, highlight).

The display change unit 121 then changes the display on the advertisement display device 310 from the advertisement to the handling description so as to display the selected display contents (step S403).

FIG. 14 is a flowchart illustrating an example of an operation associated to the person position information in the second example embodiment.

The person-information acquisition unit 170 acquires the person position information (step S427).

The start determination unit 110 determines whether the handling is started by using the person position information (step S401). For example, the start determination unit 110 determines, as the start of the handling, the entry of the person into the predetermined area after the start time.

If the handling is not started (No in step S401), the operation returns to step S427.

If the handling is started (Yes in step S401), the subsequent operation is similar to that of the first example embodiment. Note that, as the subsequent operation, the display control device 102 may execute an operation similar to the operation illustrated in FIG. 10 or 12.

Next, effects of the second example embodiment will be described.

According to the second example embodiment, in addition to the effects of the first example embodiment, there is an effect of changing the contents of the handling description to be displayed in association with the person.

The reason is as follows.

The person-information acquisition unit 170 acquires the person information related to the person who handles the target facility 320. The display change unit 121 then changes the display contents of the handling description to be displayed on the advertisement display device 310 on the basis of the acquired person information.

The second example embodiment is for displaying the contents associated to the person on the basis of the above configuration.

Furthermore, according to the second example embodiment, there is an effect of changing the contents of the handling description to be displayed in association with the history of the person.

This is because the display change unit 121 changes the display contents of the handling description to be displayed on the advertisement display device 310 on the basis of the person information and the history information.

Furthermore, according to the second example embodiment, there is an effect of changing the display on the advertisement display device 310 in response to the entry and exit of the person into and from the predetermined area for the target facility 320.

The reason is as follows.

The person-information acquisition unit 170 acquires the person position information. The start determination unit 110 and the end determination unit 130 then determine the start of the handling and the end of the handling on the basis of the person position information.

### Third Example Embodiment

A third example embodiment will be described.

First, a configuration of a display system 12 including a display control device 103 will be described as a reference for understanding the display control device 103 in the third example embodiment.

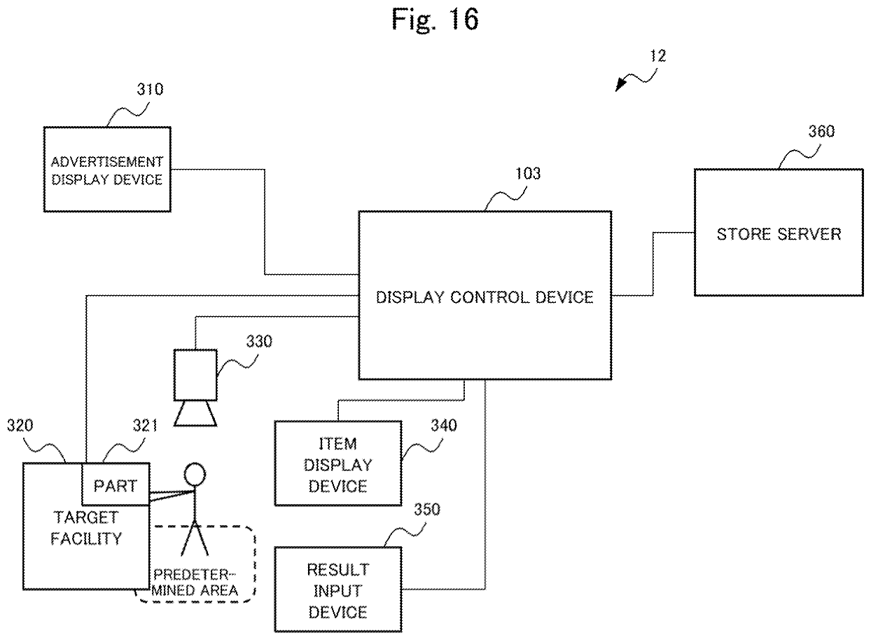

FIG. 16 is a block diagram illustrating the configuration of the display system 12 including the display control device 103 in the third example embodiment. Referring to FIG. 16, the display system 12 includes the display control device 103, an advertisement display device 310, a target facility 320, a store server 360, a person identification device 330, an item display device 340, and a result input device 350.

Since the advertisement display device 310, the target facility 320, the store server 360, and the person identification device 330 are similar to those of the second example embodiment, a detailed description thereof will be omitted.

The item display device 340 displays an item received from the display control device 103 (for example, an excerpt of items included in a handling description of the target facility 320).

The result input device 350 receives an input of a result of handling the item displayed on the item display device 340 and transmits the result to the display control device 103.

Configurations of the item display device 340 and the result input device 350 are not limited. For example, the item display device 340 and the result input device 350 may be configured by use of a touch panel. The item display device 340 and the result input device 350 may be configured by one device in this manner.

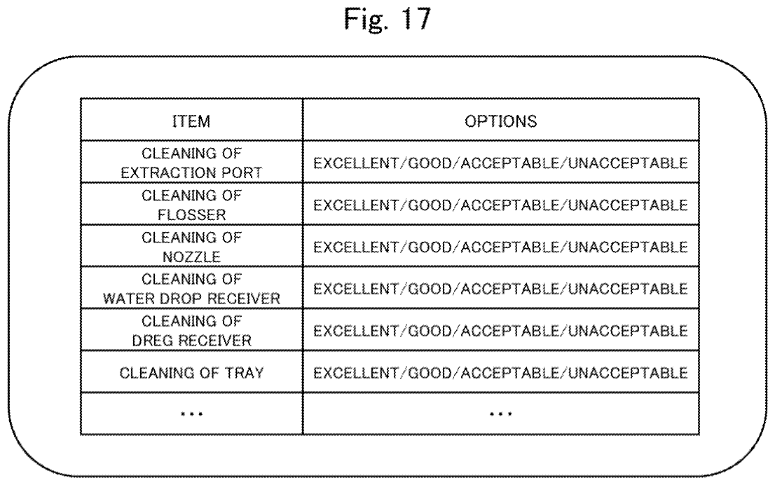

FIG. 17 is a diagram illustrating an example of displaying the item in the third example embodiment. More specifically, FIG. 17 is an example of items related to cleaning.

In the following description, it is assumed that the item display device 340 and the result input device 350 are a touch panel. The item display device 340 displays the items illustrated in FIG. 17 (such as cleaning of an extraction port) and options to be input as the result (excellent/good/acceptable/unacceptable). The result input device 350 detects contact with a position of the displayed options and determines the input of the result. For example, when detecting contact with a position of an option “excellent”, the result input device 350 determines that “excellent” has been input as the result.

For example, a manager confirms a state before and after a worker handles the target facility 320 (in the present case, before and after cleaning), and inputs the result on the basis of a confirmation result. For example, in a case where cleaning of a tray is very good but cleaning of a nozzle is insufficient, the manager may input “excellent” and “unacceptable” as results of corresponding items.

The display control device 103 transmits the item to be displayed on the item display device 340. In addition, the display control device 103 acquires the result from the result input device 350. The display control device 103 then updates history information by using the result acquired from the result input device 350. Note that the display control device 103 may include at least one of the item display device 340 and the result input device 350.

Note that the items and options in FIG. 17 are examples. The display control device 103 may display items and options different from those in FIG. 17 on the item display device 340.

Next, a configuration of the display control device 103 will be described.

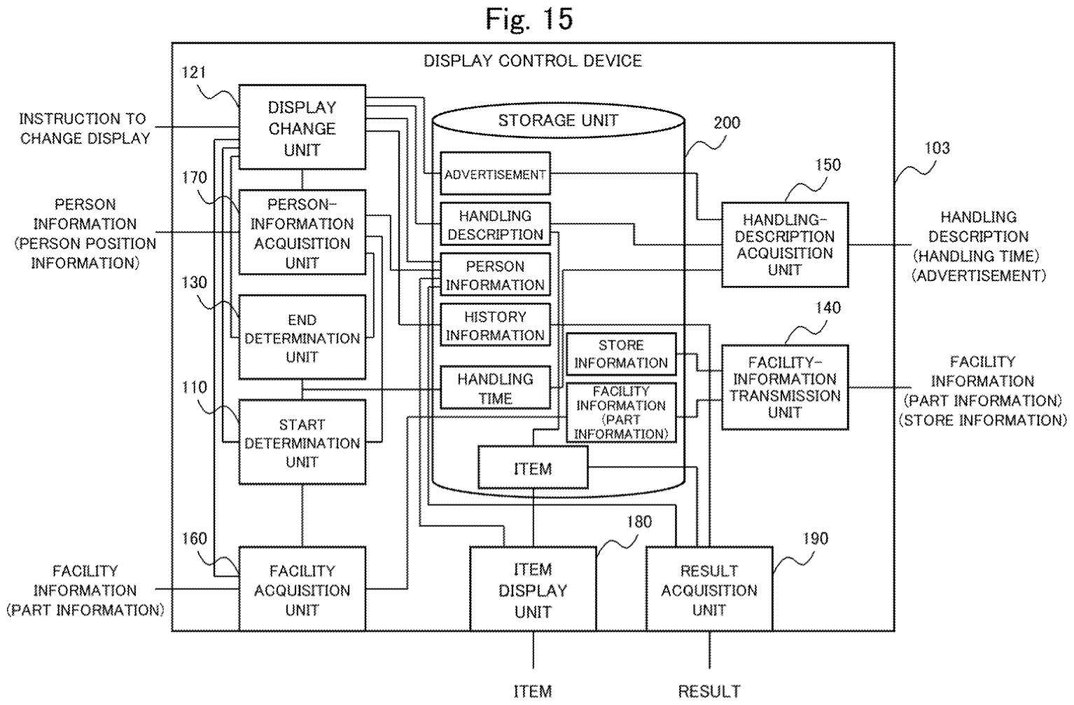

FIG. 15 is a block diagram illustrating the configuration of the display control device 103 in the third example embodiment.

Referring to FIG. 15, as compared with the display control device 102, the display control device 103 further includes an item display unit 180 and a result acquisition unit 190 in addition to the configuration of the display control device 102. Furthermore, a storage unit 200 stores the items in addition to the information in FIG. 8. Other components are similar to those of the second example embodiment. Therefore, a component specific to the third example embodiment will be described in detail, and a description of a component similar to that of the second example embodiment will be omitted.

The item display unit 180 transmits the item to be displayed on the item display device 340. Furthermore, the item display unit 180 transmits, to the item display device 340, at least one of options associated to the state before and after the handling of the target facility 320, in association with the item. In the following description, the item and options may be collectively referred to as an “item” unless the item and options are distinguished from each other for description.

The item is an item that a user of the display control device 103 (for example, a storekeeper of a store or the manager) desires to acquire as the result of handling the target facility 320. The item may be stored in the storage unit 200 by the user in advance. Alternatively, the store server 360 may transmit the item to the display control device 103 and make store the item in the storage unit 200. Alternatively, the item display unit 180 may extract the item from the handling description in accordance with a predetermined rule. Alternatively, the handling description may include the item. In order to illustrate this case, FIG. 15 connects the handling description and the item by using a line.

Note that the item display unit 180 may select the item on the basis of person information. For example, in a case where it is desired to acquire a predetermined handling result of a specific person, the item display unit 180 selects the item to be displayed on the item display device 340 on the basis of the item and the person information stored in the storage unit 200. Then, the item display unit 180 may transmit the selected item to the item display device 340.

The result acquisition unit 190 acquires a result associated to the item (for example, a selected option) from the result input device 350. The result acquisition unit 190 then updates the history information associated to the person information on the basis of the acquired result, the item, and the person information.

Note that the result acquisition unit 190 may store the acquired result or may transmit the acquired result to an external device (for example, the store server 360).

Next, an operation of the third example embodiment will be described.

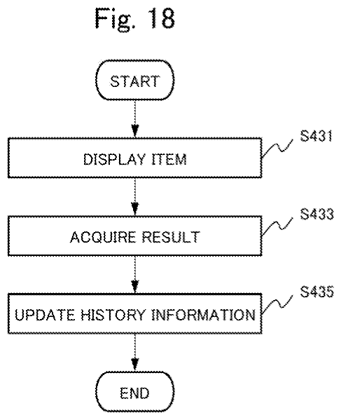

FIG. 18 is a flowchart illustrating an example of operations of displaying the item and acquiring the result in the third example embodiment.

The item display unit 180 displays the item on the item display device 340 (step S431).

The result acquisition unit 190 acquires the result from the result input device 350 (step S433).

The result acquisition unit 190 updates the history information by using the acquired result (step S435).

Next, effects of the third example embodiment will be described.

According to the third example embodiment, in addition to the effects of the second example embodiment, there is an effect of acquiring a result of handling associated to a predetermined item and updating a history.

The reason is as follows.

The item display unit 180 displays the item related to the handling on the item display device 340. The result acquisition unit 190 acquires the result of the handling related to the item from the result input device 350, and updates the history information regarding the person on the basis of the acquired result.

The third example embodiment can acquire the result of the handling associated to the item and update the history information on the basis of the above configuration.

Furthermore, the item display unit 180 may select the item by using the person information. In this case, in the third example embodiment, a result associated to the person can be acquired.

### Hardware Configuration

In the above-described example embodiments, components of each device (the display control devices 100 to 103) each represent a block of a functional unit. A part or all of the components of each device may be implemented by any combination of computers and programs.

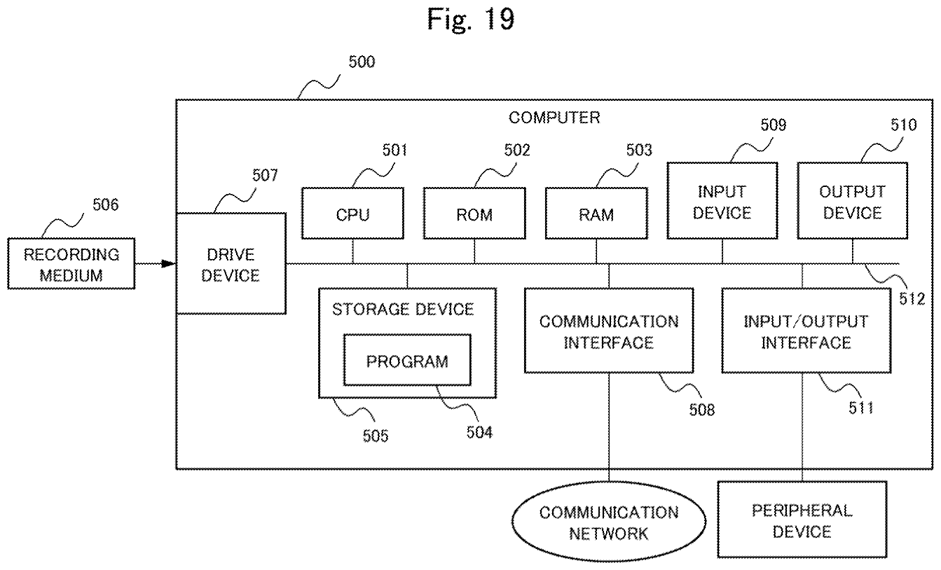

FIG. 19 is a block diagram illustrating an example of a hardware configuration of a computer 500.

Referring to FIG. 19, the computer 500 includes a central processing unit (CPU) 501, which is an example of a processor. The computer 500 further includes a read only memory (ROM) 502 and a random access memory (RAM) 503, which are examples of memories. The computer 500 further includes a program 504, a storage device 505, a drive device 507, a communication interface 508, an input device 509, an output device 510, an input/output interface 511, and a bus 512.

The program 504 includes a command (instruction) for implementing functions of each device. The program 504 is stored in advance in at least one of the ROM 502, the RAM 503, and the storage device 505.

The CPU 501 implements the functions of each device by executing the command included in the program 504. For example, when the CPU 501 of the display control device 100 executes the command included in the program 504, the computer 500 implements functions as the components of the display control device 100. The components in this case include the start determination unit 110, the display change unit 120, the end determination unit 130, the facility-information transmission unit 140, the handling-description acquisition unit 150, and the facility acquisition unit 160.

The ROM 502 stores, in addition to the program 504, data required to be stored in advance for the functions of each device, such as an initial value.

The RAM 503 stores, in addition to the program 504, data temporarily stored for the functions of each device. For example, the RAM 503 of the display control device 100 may store the advertisement and the handling description.

The storage device 505 stores, in addition to the program 504, a large amount of data that cannot be stored in the ROM 502 and the RAM 503. Furthermore, the storage device 505 may store at least one of data to be stored for a long period of time and data having a low change frequency. For example, the storage device 505 of the display control device 100 operates as the storage unit 200.

A recording medium 506 records data to be used by the computer 500. The recording medium 506 may record data acquired by the computer 500.

The drive device 507 reads the data recorded on the recording medium 506. Furthermore, the drive device 507 may write data to the recording medium 506.

The recording medium 506 may further include at least a part of the program 504. In this case, the program 504 recorded on the recording medium 506 may be read by the drive device 507, stored in the RAM 503 or the storage device 505, and supplied to the CPU 501.

The ROM 502, the storage device 505, and the recording medium 506 are examples of a non-volatile (non-transitory) recording medium.

The communication interface 508 provides an interface with a communication network. For example, the communication interface 508 of the display control device 100 may operate as a part of at least one of the facility-information transmission unit 140 and the handling-description acquisition unit 150.

Note that the program 504 may be supplied to the computer 500 from a device (not illustrated) connected to the communication network via the communication interface 508.

The input device 509 is, for example, a mouse and a keyboard, and receives an input of information from a manager or the like of the computer 500. For example, the input device 509 of the display control device 103 may operate as a part of the result acquisition unit 190.

The output device 510 is, for example, a display, and outputs (displays) information to the manager or the like. For example, the output device 510 of the display control device 103 may operate as a part of the item display unit 180.

The input/output interface 511 provides an interface with a peripheral device. For example, the input/output interface 511 of the display control device 103 may operate as a part of the item display unit 180 and the result acquisition unit 190.

The bus 512 connects the components of the above hardware.

The hardware configuration illustrated in FIG. 19 is an example. The computer 500 may include a component other than the above components, and does not have to include a part of the above components.

### Modified Example

There are various modified examples of a method for implementing each device. For example, the components of each device may be implemented by any combination of different computers and programs.

Alternatively, the plurality of components included in each device may be implemented by any combination of one computer and programs.

Alternatively, a part or all of the components of each device may be implemented by a general-purpose circuit (circuitry) or a dedicated circuit including a processor or the like, and a combination thereof.

The above circuit may be configured by a single chip or may be configured by a plurality of chips connected via a predetermined bus.

A part or all of the components of each device may be implemented by a combination of the above-described circuit or the like and a program.

In a case where a part or all of the components of each device are implemented by a plurality of computers, circuits, and the like, the plurality of computers, circuits, and the like may be arranged in a centralized manner or in a distributed manner.

In addition, each device in the example embodiments may be arranged in the store, or may be arranged in a place different from the store and connected to a device of the store (for example, the POS terminal or the store server) via the communication network. That is, each device may be implemented by a cloud computing system.

While the present disclosure has been particularly shown and described with reference to exemplary embodiments thereof, the present disclosure is not limited to these exemplary embodiments. It will be understood by those of ordinary skill in the art that various changes in form and details may be made therein without departing from the spirit and scope of the present disclosure as defined by the claims. In addition, the configurations in the example embodiments can be combined with each other without departing from the scope of the present disclosure.

A part or all of the above-described example embodiments may be described as the following supplementary notes, but are not limited to the following.

### Supplementary Note 1

A display control device including:

a start determination means for determining a start of handling of a target facility; and

a display change means for changing display on an advertisement display device from an advertisement to a handling description of the target facility when the start determination means determines the start of the handling.

### Supplementary Note 2

The display control device according to supplementary note 1, wherein

the start determination means determines, as the start of the handling, detection of a preset start time.

### Supplementary Note 3

The display control device according to supplementary note 2, wherein

the start determination means determines, as the start of the handling, an entry of a person into a predetermined area for the target facility after the start time.

### Supplementary Note 4

The display control device according to any one of supplementary notes 1 to 3, further including

an end determination means for determining an end of the handling, wherein

the display change means changes the display on the advertisement display device from the handling description to the advertisement when the end determination means determines the end of the handling.

### Supplementary Note 5

The display control device according to supplementary note 4, wherein

the end determination means determines, as the end of the handling, detection of a preset end time.

### Supplementary Note 6

The display control device according to supplementary note 5, wherein

the end determination means determines, as the end of the handling, an exit of a person from a predetermined area for the target facility after the end time.

### Supplementary Note 7

The display control device according to any one of supplementary notes 1 to 6, further including:

a facility-information transmission means for transmitting facility information related to the target facility to a store server that stores the handling description of the target facility; and

a handling description acquisition means for acquiring the handling description of the target facility from the store server, wherein

the display change means changes the display on the advertisement display device to display of the acquired handling description.

### Supplementary Note 8

The display control device according to supplementary note 7, further including

a facility acquisition means for acquiring the facility information, wherein

the facility-information transmission means transmits the facility information acquired by the facility acquisition means to the store server.

### Supplementary Note 9

The display control device according to supplementary note 8, wherein

the facility acquisition means acquires information regarding a part to be handled in the target facility, and

the display change means changes display contents of the handling description to be displayed on the advertisement display device based on the acquired part.

### Supplementary Note 10

The display control device according to any one of supplementary notes 1 to 9, further including

a person-information acquisition means for acquiring person information related to a person who handles the target facility, wherein

the display change means changes display contents of the handling description to be displayed on the advertisement display device based on the acquired person information.

### Supplementary Note 11

The display control device according to supplementary note 10, wherein

the display change means changes the display contents of the handling description to be displayed on the advertisement display device based on a history of the handling of the target facility, the history being related to the identified person.

### Supplementary Note 12

The display control device according to supplementary note 10 or 11, further including:

an item display means for displaying an item related to the handling on an item display device; and

a result acquisition means for acquiring a result of handling related to the item and updating a history related to the person based on the acquired result.

### Supplementary Note 13

The display control device according to supplementary note 12, wherein

the item display means displays at least one of options associated to a state before and after the handling of the target facility.

### Supplementary Note 14

The display control device according to supplementary note 12 or 13, wherein,

the item display means changes the item to be displayed on the item display device in association with the identified person.

### Supplementary Note 15

A display system including:

a target facility to be handled;

a store server that transmits a handling description of the target facility to a display control device;

the display control device including
a start determination means for determining a start of handling of the target facility, and
a display change means for changing display on an advertisement display device from an advertisement to the handling description of the target facility received from the store server when the start determination means determines the start of the handling; and

the advertisement display device that is controlled by the display control device and changes the display from the advertisement to the handling description of the target facility.

### Supplementary Note 16

A display control method performed by a display control device, the display control method including:

determining a start of handling of a target facility; and

changing display on an advertisement display device from an advertisement to a handling description of the target facility when the start of the handling is determined.

### Supplementary Note 17

A display control method including:

transmitting, by a store server, a handling description of a target facility to be handled to a display control device;

determining, by the display control device, a start of handling of the target facility;

changing, by the display control device, display on an advertisement display device from an advertisement to the handling description of the target facility received from the store server when the start of the handling is determined; and

changing, by the advertisement display device controlled by the display control device, the display from the advertisement to the handling description of the target facility.

### Supplementary Note 18

A recording medium recording, in a computer-readable manner, a program that causes a computer to execute:

a process of determining a start of handling of a target facility; and

a process of changing display on an advertisement display device from an advertisement to a handling description of the target facility when the start of the handling is determined.

This application is based upon and claims the benefit of priority from Japanese patent application No. 2019-053723, filed on Mar. 20, 2019, the disclosure of which is incorporated herein in its entirety by reference.

### REFERENCE SIGNS LIST

10 display system
11 display system
12 display system
100 display control device
101 display control device
102 display control device
103 display control device
110 start determination unit
120 display change unit
121 display change unit
130 end determination unit
140 facility-information transmission unit
150 handling-description acquisition unit
160 facility acquisition unit
170 person-information acquisition unit
180 item display unit
190 result acquisition unit
200 storage unit
310 advertisement display device
320 target facility
321 part
330 person identification device
340 item display device
350 result input device
360 store server
500 computer

### 501 CPU

### 502 ROM

### 503 RAM

504 program
505 storage device
506 recording medium
507 drive device
508 communication interface
509 input device
510 output device
511 input/output interface
512 bus

What is claimed is:

1. A display control device comprising:
a memory; and
at least one processor coupled to the memory,
the processor performing operations, the operations comprising:
determining a start of handling of a target facility; and
changing display on an advertisement display device from an advertisement to a handling description of the target facility when determining the start of the handling.

2. The display control device according to claim 1, wherein the operations further comprise
determining, as the start of the handling, detection of a preset start time.

3. The display control device according to claim 1, wherein the operations further comprise
determining, as the start of the handling, an entry of a person into a predetermined area for the target facility after the start time.

4. The display control device according to claim 1, wherein the operations further comprise:
determining an end of the handling, and
changing the display on the advertisement display device from the handling description to the advertisement when determining the end of the handling.

5. The display control device according to claim 4, wherein the operations further comprise
determining, as the end of the handling, detection of a preset end time.

6. The display control device according to claim 4, wherein the operations further comprise
determining, as the end of the handling, an exit of a person from a predetermined area for the target facility after the end time.

7. The display control device according to claims 1, wherein the operations further comprise:
transmitting facility information related to the target facility to a store server that stores the handling description of the target facility;
acquiring the handling description of the target facility from the store server; and
changing the display on the advertisement display device to the acquired handling description.

8. The display control device according to claim 7, wherein the operations further comprise:
acquiring the facility information, and
transmitting the acquired facility information to the store server.

9. The display control device according to claim 8, wherein the operations further comprise
acquiring information regarding a part to be handled in the target facility, and
changing display contents of the handling description to be displayed on the advertisement display device based on the acquired part.

10. The display control device according to claim 1, wherein the operations further comprise:
acquiring person information related to a person who handles the target facility, and
changing display contents of the handling description to be displayed on the advertisement display device based on the acquired person information.

11. The display control device according to claim 10, wherein the operations further comprise
changing the display contents of the handling description to be displayed on the advertisement display device based on a history of the handling of the target facility, the history being related to the identified person.

12. The display control device according to claim 10, wherein the operations further comprise:
displaying an item related to the handling on an item display device; and
acquiring a result of handling related to the item and updating a history related to the person based on the acquired result.

13. The display control device according to claim 12, wherein the operations further comprise
displaying at least one of options associated to a state before and after the handling of the target facility.

14. The display control device according to claim 12, wherein the operations further comprise
changing the item to be displayed on the item display device in association with the identified person.

15. (canceled)

16. A display control method performed by a display control device, the display control method comprising:
determining a start of handling of a target facility; and
changing display on an advertisement display device from an advertisement to a handling description of the target facility when the start of the handling is determined.

17. (canceled)

18. A non-transitory computer-readable recording medium embodying a program that causing a computer to perform a method, the method comprising:
determining a start of handling of a target facility; and
changing display on an advertisement display device from an advertisement to a handling description of the target facility when the start of the handling is determined.
